(19) United States
(12) Patent Application Publication
(10) Pub. No.: US 2003/0065546 A1
(43) Pub. Date: Apr. 3, 2003

(54) System and method for improving management in a work environment

(76) Inventors: Ravi Srinath Gorur, Centreville, VA (US); James Michael Harris, Reston, VA (US); Michael Lee Hosey, Bristow, VA (US); Roderick Peter Silton, Herndon, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/073,142

(22) Filed: Feb. 13, 2002

Related U.S. Application Data
(60) Provisional application No. 60/325,195, filed on Sep. 28, 2001.
(60) Provisional application No. 60/325,218, filed on Sep. 28, 2001.
(60) Provisional application No. 60/325,194, filed on Sep. 28, 2001.

(51) Int. Cl. G06F 17/60

(52) U.S. Cl. 705/9

(57) ABSTRACT

The present invention addresses the aforementioned needs by providing a mechanism that enables team leaders to effectively manage the complex interrelationships of deliverables within an organization. In one embodiment, a contract object is defined that represents an agreement between a provider and a customer, wherein the provider delivers some product or service to the customer within a certain timeframe.

The present application claims priority to Provisional Application No. 60/325,195, entitled “SYSTEM AND METHOD FOR IDENTIFYING INDIVIDUALS HAVING A DESIRED SKILL SET,” filed Sep. 29, 2001, Provisional Application No. 60/325,218, entitled “SYSTEM AND METHOD FOR IMPROVING COLLABORATION BETWEEN ENTITIES IN A WORK ENVIRONMENT,” filed Sep. 29, 2001, and Provisional Application No. 60/325,194, entitled “SYSTEM AND METHOD FOR IMPROVING OPERATIONAL EFFICIENCY THROUGH PROCESS AUTOMATION,” filed Sep. 29, 2001, each of which is incorporated herein by reference in its entirety.

### CROSS-REFERENCE TO OTHER APPLICATIONS

The following applications of common assignee contain some common disclosure, and are believed to have an effective filing date identical with that of the present application.

“System and Method for Identifying Individuals Having a Desired Skill Set,” Attorney Docket No. INST001/01US, application Ser. No. ______, incorporated herein by reference in its entirety.

“System and Method for Improving Operational Efficiency Through Process Automation,” Attorney Docket No. INST003/01US, application Ser. No. ______, incorporated herein by reference in its entirety.

### BACKGROUND

1. Field of the Invention

The present invention relates generally to enterprise management, and more specifically to a system and method for improving collaboration between entities in a work environment.

1. Discussion of the Related Art

Complex multi-team collaborations depend upon intricate relationships, information sharing, and deliverables between teams. Through frequent project review meetings, team leaders oversee the current status of various tasks to ensure that the wider ranging goals of the project will be met. In this process, team leaders define and manage various inter-team deliverables that are critical to the success of the project. Inter-team deliverables are often established and managed on an informal basis (e.g., telephone calls, email, etc.).

In many instances, an inter-team deliverable will depend upon the successful completion of another inter-team deliverable. For example, when the Engine Team fails to inform the Steering Team that a change in the progress of a deliverable has been made, and the Steering Team moves forward with testing a design based on outdated information, that testing time is wasted.

Interruptions in the completion of deliverables can ripple through the entire project, causing major delays in the overall project completion. Even with the use of project planning software, the unexpected deviations from existing plans can create havoc due to the intricate nature of team-to-team choreography. When coordination efforts begin to break down because of the deviation from existing plans, team leaders are forced to increase their administrative efforts to regain control, thereby introducing further overhead into the overall project management. What is needed therefore is a mechanism that enables improved handling of team-to-team choreography.

### SUMMARY

The present invention addresses the aforementioned needs by providing a mechanism that enables team leaders to effectively manage the complex interrelationships of deliverables within an organization. In one embodiment, a contract object is defined that represents an agreement between a provider and a customer, wherein the provider delivers some product or service to the customer within a certain timeframe.

### BRIEF DESCRIPTION OF THE DRAWINGS

FIG. 1 is an embodiment of a contract state machine.

FIG. 2 is an embodiment of a contract object framework.

FIG. 3 is an embodiment of a user interface including contracts and contract participants.

FIGS. 4-6 are user interface screens for obtaining details of a contract.

### DETAILED DESCRIPTION

An embodiment of the invention is discussed in detail below. While specific implementations are discussed, it should be understood that this is done for illustration purposes only. A person skilled in the relevant art will recognize that other components and configurations may be used without departing from the spirit and scope of the invention.

The management of complex multi-team collaborations is a difficult proposition. Managers are often responsible for coordinating team efforts in the various projects in which they are at least peripherally involved. This coordination problem is especially difficult in situations where the project commitments have not been specifically defined. Increased uncertainty can therefore result.

Multi-team collaborations can exist on various levels. In one example, a formal commitment can be made between two groups within the organization. This formal commitment may reflect the terms of the relationship between the two groups after months of extensive project planning. At this stage, the project planning may have defined the final specifications of the deliverable, the detailed timeline of the stages of the deliverable, the specific individuals that would be involved in each portion of the deliverable, the layers of communication between the two groups, etc. As would be appreciated, the extensive project planning would continue as the groups continued to “manage” the project.

In another example, multi-team collaboration can be based on an informal commitment between two groups within the organization. This informal commitment may exist merely as a general understanding of a potential relationship. This form of commitment is equally important to project planning as it reflects the beginning of a relationship between two groups. For example, this stage of agreement may reflect the acknowledgement by the two groups that a deliverable is required in the future and that a commitment would be forthcoming at a later date. Thus, a tentative agreement may exist notwithstanding the fact that the details of the deliverable have not yet been defined.

The lack of definition in the deliverable and/or relationship increases the difficulty in maintaining proper coordination between the groups. At this point in the process, no individual may yet have been designated to produce the deliverable. Further, the commitment by a particular group may be tenuous as it is based on future work to be defined. In this ill-defined context, coordination is difficult because little substance is available to be coordinated.

Multi-team management solutions should be flexible to deal with these various levels of planning efforts. As would be appreciated, an entire spectrum of commitment levels can exist within an organization due to the fact that informal commitments may evolve into more formal commitments.

In the present invention, an enterprise management tool is provided which enables entities within an organization to track various commitments within the organization. In one embodiment, this management tool is based on the concept of a contract. A contract is an agreement between entities within an organization. Typically, this agreement is for a first entity to deliver some product and/or service to a second entity within some time frame.

The entity that delivers the product and/or service is referred to as the “provider” of a contract. The entity that is to receive the product and/or service is referred to as the “customer” of a contract. The time frame the product and/or service will be delivered is referred to as the due date of the contract.

Although a contract is an agreement between entities, it need not model a contract in the legal sense. The contract reflects an agreement between one or more providers of a deliverable and one or more customers of that deliverable. As will be described in greater detail below, a contract can also provide a portal for managers to advertise products and/or services they intend to deliver, who are the receivers of the products and/or services, and when they intend to deliver those products and/or services.

In one embodiment, the contract provides agreement information without revealing the details of how the provider will produce the deliverable. The contract also need not reveal the details of how the customer will use the deliverable. In this framework, the promise is separated from the details of the generation/use of the deliverable. This separation enables the tracking and monitoring of informal and tentative agreements as they gradually mature into more formal agreements.

Contracts can be captured in the context of a collaborative work environment. In one embodiment, a contract is expressed as a software object. As noted, the contract is primarily intended to represent the agreement. Details of the deliverable need not be revealed. Accordingly, the attributes of the contract object need not be extensive. As would be appreciated, however, the particular set of attributes of a contract object would be dependent upon the particular implementation and application within the collaborative work environment. In one embodiment, the contract object includes Name, Owner, Contract Description, Due Date, Contract State, and Current State Date attributes.

The Owner attribute identifies a user (or a role) that has created the contract object. The Owner attribute can be used for permission checking and access control.

The Contract Description attribute can be used to provide a high-level description of the project. As noted, one or more attributes that are associated with the details of the contract deliverable need not be provided.

The contract object also includes a Contract State attribute. The Contract State attribute is used to identify a state of the contract. In one embodiment, the Contract State attribute can have values of proposed, agreed, delivered, and completed. In other embodiments, the Contract State attribute can have values taken from a set of user-defined values.

It should be noted that a contract state, or the overall health of the contract, can be influenced by other objects (e.g., task activity objects) within the system. For example, a change in an attribute of an activity object associated with a contract can influence whether the contract state should be changed. For example, if an activity state changes to abandoned, then a contract state may be triggered to change from agreed to proposed, thereby indicating the revocation of the contract.

In general, contract state changes can be based on changes in other objects within the system or on manual input by permitted users. As would be appreciated, only individuals with appropriate authorization would be permitted to invoke a contract state change.

In one embodiment, contract-state transitions are controlled by a contract state machine. The contract state machine provides a mechanism for methodically capturing and tracking an agreement between entities in the organization.

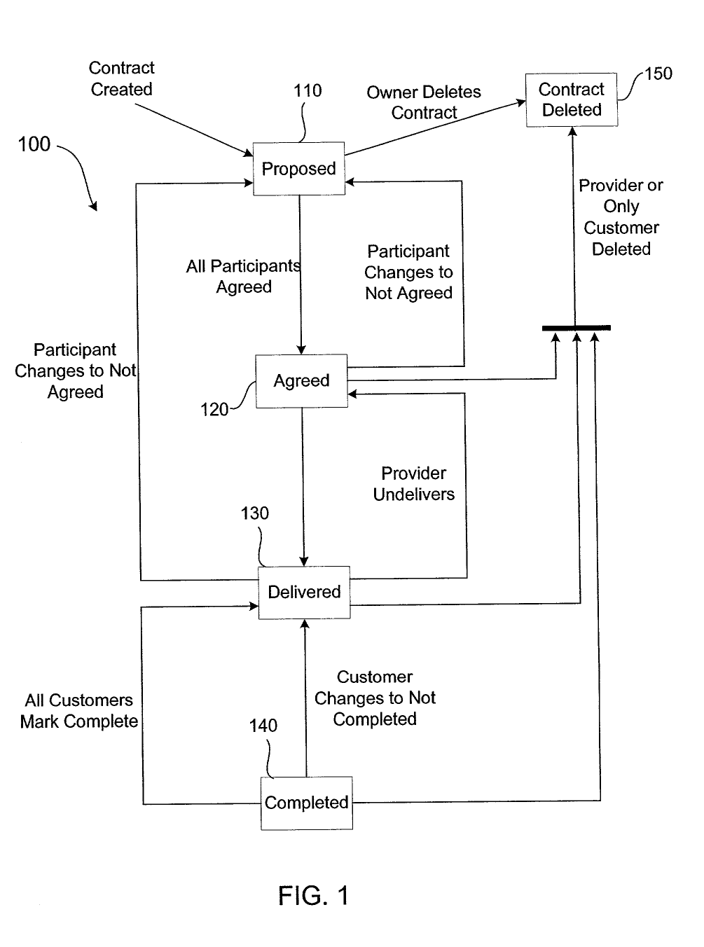

FIG. 1 illustrates an embodiment of a contract state machine. Contract state machine 100 has four primary states, proposed state 110, agreed state 120, delivered state 130, and completed state 140. Contract state machine 100 also has a contract deleted state 150, which can be entered only from proposed state 110. Specifically, a contract cannot be deleted if any participant has agreed to the terms of the contract, thereby causing the contract state machine to enter into agreed state 120.

From proposed state 110, the provider(s) and customer(s) can negotiate the contract prior to entering agreed state 120. In one embodiment, this negotiation process is supported by a persistent dialog that records the communications between the provider(s) and customer(s). The persistent dialog is stored and made available to other parties that are interested in the context of the contract. The persistent dialog is described in greater detail below.

Once all participants have agreed to the contract, contract state machine 100 enters into agreed state 120. In agreed state 120, the description of the contract is set, thereby fixing the scope of the contract. When the provider produces the deliverable, then contract state machine 100 enters delivered state 120. If the deliverable is acceptable, then the customer(s) can indicate that the contract is complete, thereby enabling the contract state machine to enter completed state 140.

In the illustrated embodiment of FIG. 1, participants to the contract can also decide to revoke the contract. Upon revocation, contract state machine 100 will return to proposed state 110 from either delivered state 130 or agreed state 120. A re-negotiation process would then commence at proposed state 110.

A participant to the contract can also be deleted. As illustrated in the embodiment of FIG. 1, the deletion of a participant can lead to the transition of contract state machine 100 from either completed state 140, delivered state 130, or agreed state 120 to proposed state 110. This scenario reflects a significant change in the contract itself. Here, either the provider or the sole customer has been deleted. The contract as it exists would therefore be rendered ineffective. At that point, the contract would merely represent a proposal to a new set of potential contract participants. The negotiation process would therefore begin anew from proposed state 110.

To illustrate the benefits of the contract object in a collaborative work environment, an example use scenario is described. In this scenario, assume that a software development project has begun. This software development project is based on a core application component that is being developed by an application development group. It is also envisioned that the software development project may also require a user interface component, the specification of which has not yet been defined.

In this situation, the manager of the application development group can create a contract that advertises the future need for a user interface component. As a contract customer, the manager of the application development group can create a contract object that describes the general need at a high level, while also specifying a projected due date months into the future. This contract object can be sent to one or more user interface development groups (i.e., potential contract providers). At this point in the process, the contract object would be in proposed state 110.

Upon review of the contract, a potential contract provider can determine whether they may have the resources available in the projected timeframe. If the resources are not likely to be available, then the potential contract provider would not agree to the contract, leaving the contract object in proposed state 110. If the resources are anticipated to be available, then the potential contract provider can agree to the contract, thereby enabling the contract object to move to agreed state 120. Alternatively, the potential contract provider can also negotiate the terms of the contract. For example, the potential contract provider can propose an alternate due date that would enable his group to realistically produce the contract deliverable.

At this point in the project planning process, it should be noted that the coordination between development teams can proceed even though the contract deliverable has not yet been defined. For example, while the content and layout of the user-interface deliverable may not be defined, the individuals that may participate in the development and management may be identified and kept informed of the latest developments in the deliverable specification.

This example is reflective of many project scenarios where the specification of the deliverable will be incrementally defined as the project matures. The lack of specification, however, should not inhibit the planning efforts for the inter-team deliverable. In fact, methodical coordination at an early stage of a deliverable may likely offer the greatest savings in preventing wasted administrative efforts (e.g., monitoring tentative agreements).

It is a feature of the present invention that the contract object enables the methodical capture of information early in the project planning process. This methodical capture enables significant advances in the efficiency of overall project planning. One example of increased project planning efficiency is in the communication of information.

In the present example, the contract object is defined by the manager of the application development group. This contract object publicizes the need for a user interface component to a potential contract provider. As noted, the potential contract provider need not immediately respond to the contract proposal leaving the contract in proposed state 110.

In general, the delay in the response by the potential contract provider may not necessarily impact the contract originator (i.e., the contract customer). In fact, the contract customer may have created the contract object merely to capture an early projection of a future need. This early capture and publication of a future need enhances the efforts of overall project planning by increasing communication between potential parties to the contract without incurring the costs of a series of face-to-face meetings.

As the development of the core application component matures, the manager of the application development group may identify a more refined estimate of the specifications and deadline of the user interface component. In the example of a refined due date, the Due Date attribute of the contract object can be modified. Modification of the projected due date in the contract can trigger an alert for the potential contract provider. For example, the modification of the projected due date can trigger an email or other form of communication that alerts the potential contract provider of a change in the contract. This change in the contract may lead the potential contract provider to decide that the contract deliverable is now feasible for his group. Acceptance of the contract by the potential contract provider can then be initiated.

More generally, the contract customer and the contract provider can engage in a negotiation over the terms of the contract. While the negotiation process can represent an actual exchange of offers and counteroffers, the negotiation process can also represent the definitional stage of the contract.

In the example provided above, the manager of the application development group has created the contract without knowing the specifications of the product to be delivered. In this context of this example, the negotiation process can represent the process by which the manager of the application development group continually alerts the potential contract provider whenever additional portions of the specification of the user interface component have been defined. In one embodiment, the communication of additional portions of the specification can be provided through a series of asynchronous communications that are recorded in a persistent dialog. The persistent dialog can therefore represent an archived record of the contract negotiation process.

As would be appreciated, contract state machine 100 enables the contract negotiation process to continue throughout the contract's lifetime. Decisions made during the negotiation process (e.g., objections or withdrawing from the contract) can lead to changes in the contract state. Thus, participants (i.e., providers and customers) of the contract play an active role in the state-driven lifecycle of the contract.

It is a feature of the present invention that the state changes in contract state machine 100 can be used to initiate various alerts. In one embodiment, rules can be defined to produce an action upon the satisfaction of a condition. This condition can be stated in the context of an event, such as the entering or exiting of a particular state in contract state machine 100. For example, a rule can be defined such that all contract participants are alerted when contract state machine 100 changes state. In another example, a rule can be defined such that a participant is notified when they are added or removed as the provider or customer of a contract.

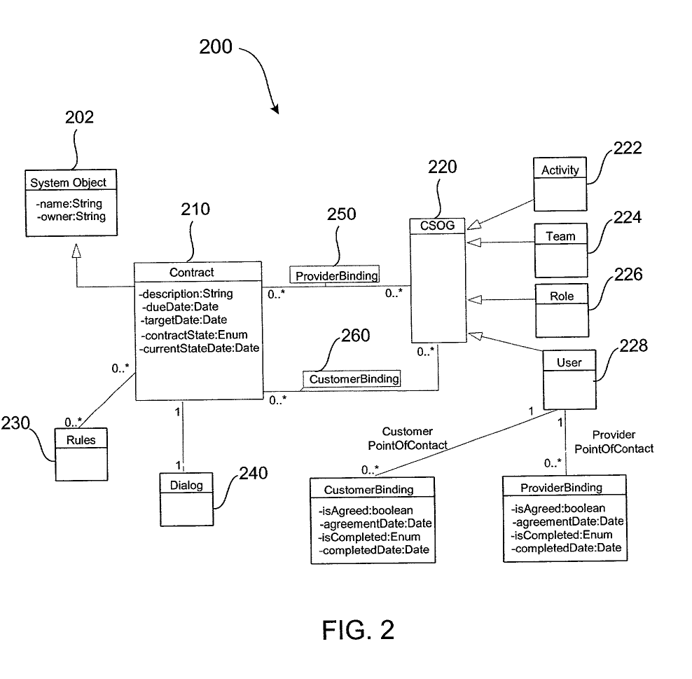

Having described the general operational characteristics of a contract, an embodiment of a contract object framework is now provided with reference to the class diagram illustrated in FIG. 2. Class diagram 200 details the relationships between contracts 210, contract system object group (CSOG) 220, rules 230, and dialog 240. As described in the embodiment above, contracts object 210, an extension of base system object 202, can include Name, Owner, Contract Description, Due Date, Contract State, and Current State Date attributes.

In the framework of class diagram 200, a contract is an agreement between one or more contract provider CSOGs 220 and one or more contract customer CSOGs 220. In general, a CSOG is a synonym for a system object that can participate in a contract as a provider or a customer. CSOG 220 is generally an activity or resource.

In the illustrated embodiment of FIG. 2, resources are exemplified by users 228, roles 226, and teams 224. Users 228, roles 226, and teams 224 can be assigned to tasks, receive notifications, and otherwise interact with the system. While the following description of resources is focused on users, roles, and teams, it should be noted that resources can also be used to represent inanimate objects as well.

User object 228 is the basic mechanism for providing information about a user. In one embodiment, user object 228 includes User Id, Password, First Name, Last Name, Phone Number, Email Address, Office Location, and Account State attributes.

Team object 224 is the mechanism for providing information about a group of users bound together for some common cause. That cause could be organizational (i.e. common manager), role related (common type of work), task related (common deliverable), or other cause (e.g. common location, etc.). Teams enable the assignment of entire groups of users to activities and rules. Teams also enable the description of the organizational structure of the user community.

In one embodiment, team object 224 includes Team Name, Team Lead, and Team Description attributes and a membership table. The membership table includes a list of all current members (i.e., users or other teams). The membership table is dynamically updateable to reflect team membership changes.

Finally, roles are a mechanism to assign work items and automation actions to users indirectly. Roles are useful to help convey responsibility, and ease automation configuration. Roles are significant in that they may be assigned as participants to activities and rules and then resolved to an actual user independently within various scopes of the organization. For example the quality assurance (QA) representative for Project X may be Sue, while that same role for Project Y may be Fred. One set of rules and rule actions from the corporate handbook that pertain to a project's QA representative can thus be applied to tasks in both projects without need for change.

One way to describe a role is that it is a named type of work that is applied to a person within some scope (e.g. Sue is the QA representative for Project X). Similarly, a role can be associated with a particular team within one scope and a different team within a different scope.

In one embodiment, role object 226 includes Name, Description, and Role Resolution attributes. Here, the Resolution attribute identifies a user or team to which the role resolves.

As noted above, CSOG 220 can represent activities in addition to resources (e.g., users, roles, and teams). In the illustrated embodiment of FIG. 2, activities are represented by activity object 222.

In one embodiment, various work-related activities can be defined, including project, summary task, task, and workflow activities. A project activity is an association of activities that are focused on completing some objective. Projects do not have work associated with them directly but are the incorporation of several smaller units of work. Projects can be larger in scale and have some corporate visibility associated with them. Summary tasks are similar to projects as they represent a collection of smaller activities. Summary tasks generally do not have corporate visibility but they are used to summarize work in progress. Tasks are the smallest unit of activity and represent the building blocks of projects and summary tasks. Finally, workflow activities represent activities that have predefined workflows and processes associated with them.

In one embodiment, activity object 222 can be defined with the following attributes: Name, Description, Duration (e.g., number of work days required to complete activity), Effort (e.g., number of hours expected to complete the activity), Due Date, Start Date, End Date, Date Calculation Mode (e.g., how Start and End Dates are calculated), Percent Complete, Percent Complete Calculation Mode, Priority, (e.g., high, medium, low), Confidence Level (e.g., likelihood that a user believes the activity will be completed on time), Activity State (e.g., blocked, ready, active, completed, abandoned), Yellow Page Index (e.g., listing of skills keywords), Activity Status, Acknowledgement (e.g., indication that participant has received and accepts an activity), and Dialog. Particular types of activity objects (i.e., project, summary task, task, and workflow activity objects) can use all or part of the set of attributes.

As thus described, in one embodiment, activity object 222 can represent a project, a summary task, a task, or a workflow activity. Any one of these activity objects can represent member elements of CSOG 220.

The participation of an activity as a contract customer or as a contract provider illustrates the unique role of the contract. As noted, the contract can be used to express an agreement between contract parties without revealing the details of how the provider will produce the deliverable. Details of a particular deliverable can be embodied within an activity. For example, the details of the production of a deliverable can be embodied within a project or summary task activity. This project or summary task activity can then participate as a contract provider using an activity CSOG 220. The contract itself would be used to express the agreement between the contract participants. This use scenario is in contrast to the use of resources (e.g., users) as contract participants.

In the illustrated embodiment of FIG. 2, participants are bound to contract object 210 using ProviderBinding 250 and CustomerBinding 260. In one embodiment, ProviderBinding 250 includes Provider, Point of Contact, IsAgreed, AgreementDate, IsDelivered, and DeliveryDate attributes.

The Provider attribute identifies the CSOG 220 that is the provider of the contract.

The Point of Contact attribute identifies the user representing a provider point of contact. In one embodiment, the default value of the Point of Contract attribute is the user object 228 of the owner of the activity if the contract provider is an activity 222, or is the user object 228 of the user if the contract provider is a user 228.

The IsAgreed attribute indicates whether the provider has agreed to the terms of a contract. In one embodiment, the attribute takes a value of either Agreed or Not Agreed.

The AgreementDate attribute identifies the date the provider agreed to the terms of a contract.

The IsDelivered attribute indicates whether the provider has delivered the agreed upon contract terms. In one embodiment, the attribute takes a value of either Delivered or Not Delivered.

Finally, the DeliveryDate attribute identifies the date the provider delivered the agreed upon contract terms.

In a similar manner, CustomerBinding 260 includes Customer, Point of Contact, IsAgreed, AgreementDate, IsDelivered, and DeliveryDate attributes.

As further illustrated in the embodiment of FIG. 2, dialog 240 and rules 230 are also associated with contract object 210. As noted, dialog 240 is a persistent message forum that is linked to contract object 210. This forum allows users to communicate information about the contract to increase understanding of the focus and context of the contract or to negotiate details of the contract. In various example, the dialog can be used to (1) negotiate the terms of a contract, (2) communicate the details and expectations of an assignment, or (3) coordinate efforts of an activity.

In one embodiment, dialog 240 includes Entry Person, Date Time, and Message attributes. The Entry Person attribute identifies the name of the person that entered text into the dialog, the Date Time attribute identifies the date and time text was entered into the dialog, and the Message attribute includes the text message that was entered into Dialog 240.

Rule 230 is an object that contains the abstract description for the Event, Condition and Action components that form the rules. As noted, rules can be defined to produce an action upon the satisfaction of a condition that can be stated in the context of an event. One example of an event is the entering or exiting of a particular state in contract state machine 100.

In one embodiment, rule object 230 includes Name, Description, Digest, and Rule Definition attributes. Here, the Description attribute provides a description of the rule's intent, the Digest attribute is a system-generated summary of the Rule Definition, and the Rule Definition attribute contains the event-condition-action (ECA) components of the rule. ECA rules can be stated such that when a certain combination of events occur, and a certain combination of conditions are true, then a certain set of actions occur.

Having described a general contract object framework, a description of the application of contracts in a collaborative work environment is now provided. As noted, contracts represent agreements between entities within an organization. This agreement defines a peer-to-peer relationship between these entities. Contracts also include a state machine that enables visibility into the various stages within the lifecycle of the contract. Significantly, contracts can be proposed even if the details of the deliverable have not yet been defined, thereby enabling managers to track various formal or informal commitments within the organization.

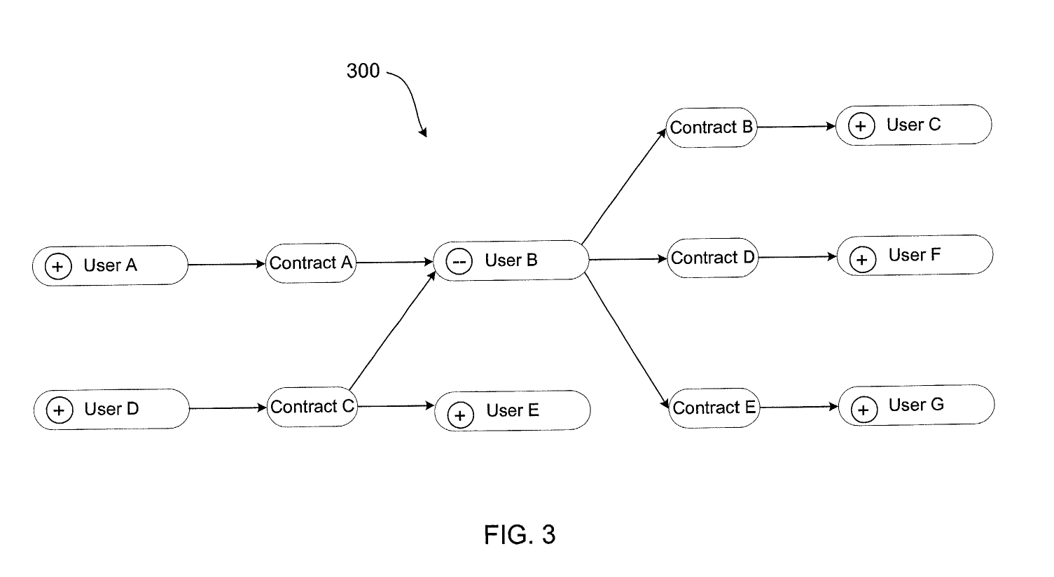

FIG. 3 illustrates an embodiment of a user interface that enables the tracking of commitments within the organization. User interface screen 300 includes seven users A-G and five contracts A-E. As illustrated, contract A is a contract between user A (provider) and user B (customer); contract B is a contract between user C (provider) and user B (customer); contract C is a contract between user D (provider) and users B and E (customers); contract D is a contract between user B (provider) and user F (customer); and contract E is a contract between user B (provider) and user G (customer). These various peer-to-peer contract relationships represent the set of contracts associated with user B.

Navigation through the contract space within the organization is enabled through the selection of the various user icons. If the icon for a user (e.g., user A) includes a “+” symbol, then further contract relationships have been hidden. If the icon for a user (e.g., user B) includes a “−” symbol, then all contract relationships for that user have been shown. Selection of the various user icons thereby enables a selected view of the existing contracts within the organization. This view further enables project assessment and resource utilization analysis.

It should be noted that user interface screen 300 only includes contracts that exist between users. As described above, however, contracts can represent peer-to-peer agreements between resources or activities. Thus, in other scenarios, the contract space can also include relationships between various users, roles, teams, and activities (e.g., project, summary task, task, or workflow activities).

In accordance with the present invention, general project management can be effected through a global view of all contracts and contract participants. This global view can display the interrelationships between contracts and contract participants. If a team leader or team member needs to modify the status of a contract, thereby modifying a chain of contracts, then the system can immediately assess the full impact of the change on other contracts and their related participants and timeframes. All affected parties can then be notified automatically of the changes using predefined rules without resorting to meetings or a series of individual personal contacts.

As demonstrated by user interface screen 300, contract objects can be displayed in a user interface as intersections between contract provider and contract customer objects. In a collaborative work environment, contract details are viewable by interested parties by selecting the contract object.

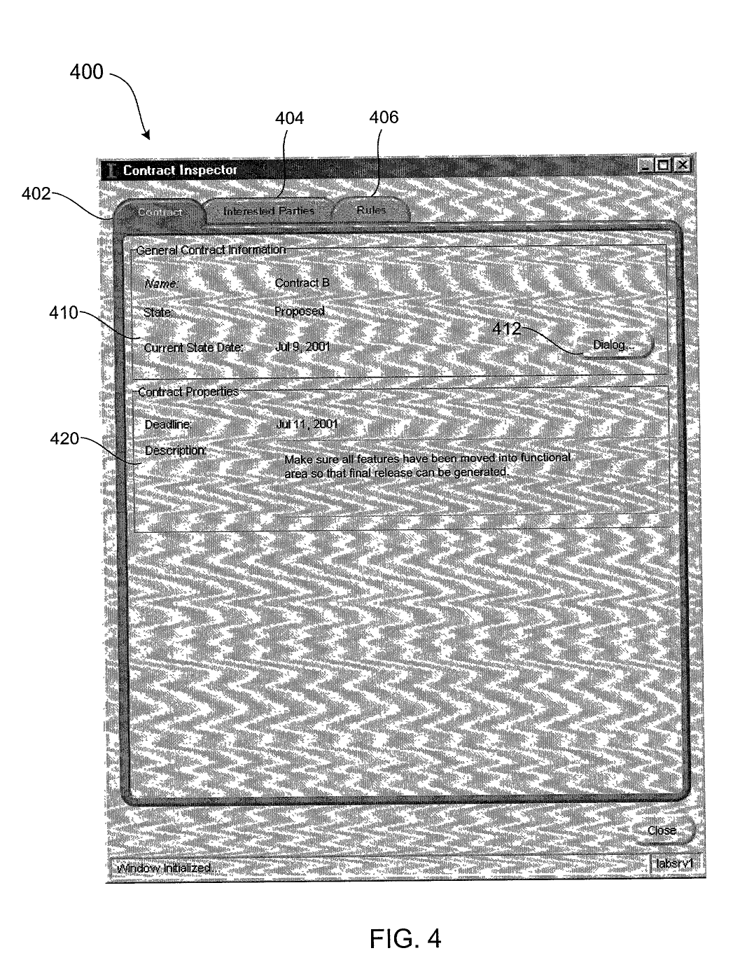

FIGS. 4-6 illustrates a set of user interface screens that enables the display of contract detail information. User interface screen 400 of FIG. 4 illustrates the details of contract C. Specifically, user interface screen 400 includes contract Name, State, and Current State Date information in information panel 410. Information panel 410 also includes a Dialog button 412 that enables the persistent dialog to be obtained. User interface screen 400 also includes information panel 420 that includes the contract Description as well as a contract Deadline.

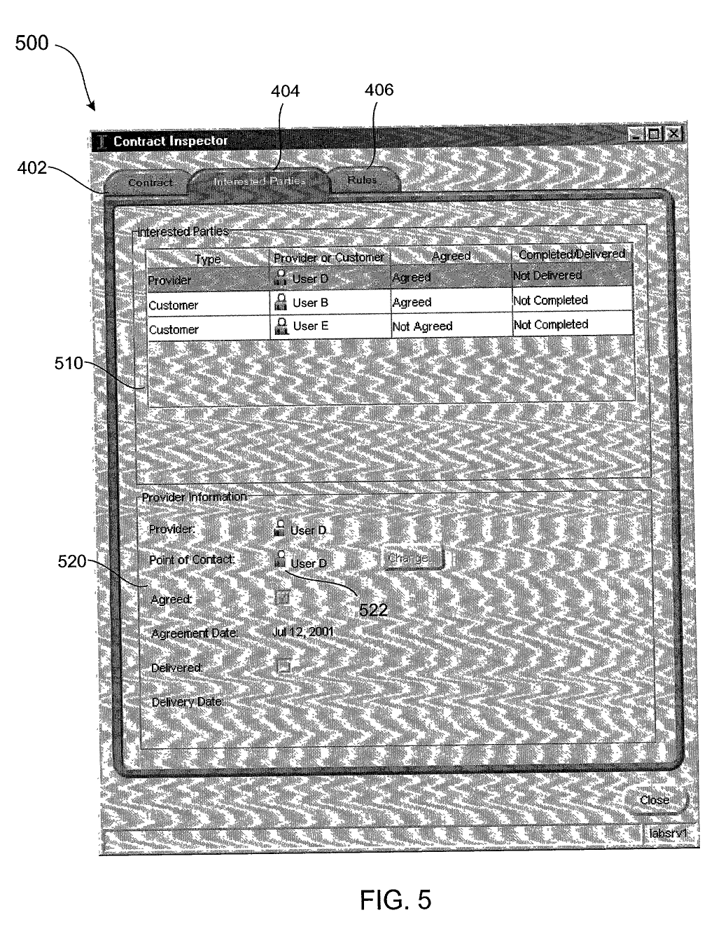

If Interested Parties tab 404 is selected, then user interface screen 500 of FIG. 5 is presented. User interface screen 500 illustrates the participants of contract C. Specifically, user interface screen 500 includes a listing of each of the participants of contract C in information panel 510. Here, user D is a provider, while users B and E are customers. Users D, B, and E are listed in respective rows in information panel 510. Each row in information panel 510 includes the Type of participant (i.e., provider or customer), the identification of the participant, whether the participant has agreed to the contract, and whether the contract has been completed or delivered.

Details of a particular contract participant are provided in information panel 520. In the illustrated embodiment, the participant information includes the point of contact (POC) information that is provided by either ProviderBinding 250 or CustomerBinding 260. The information on the POC can be obtained by selecting the POC icon 522.

The selection of POC icon 522 represents one of the benefits of improving communication within the organization. For example, using user interface screen 300, a user can navigate through the contracts space to identify a particular deliverable within the organization. By selecting a contract icon, status information for that contract can be obtained through user interface screen 400. If further information on the contract needs to be obtained, the POC can be identified through user interface screen 500. Contact information (e.g., location, telephone number, pager number, email address, etc.) for the POC is obtained by selecting the POC icon 522. Communication with the POC can then commence. What results therefore is increased efficiency in the access of information concerning ongoing work within the organization.

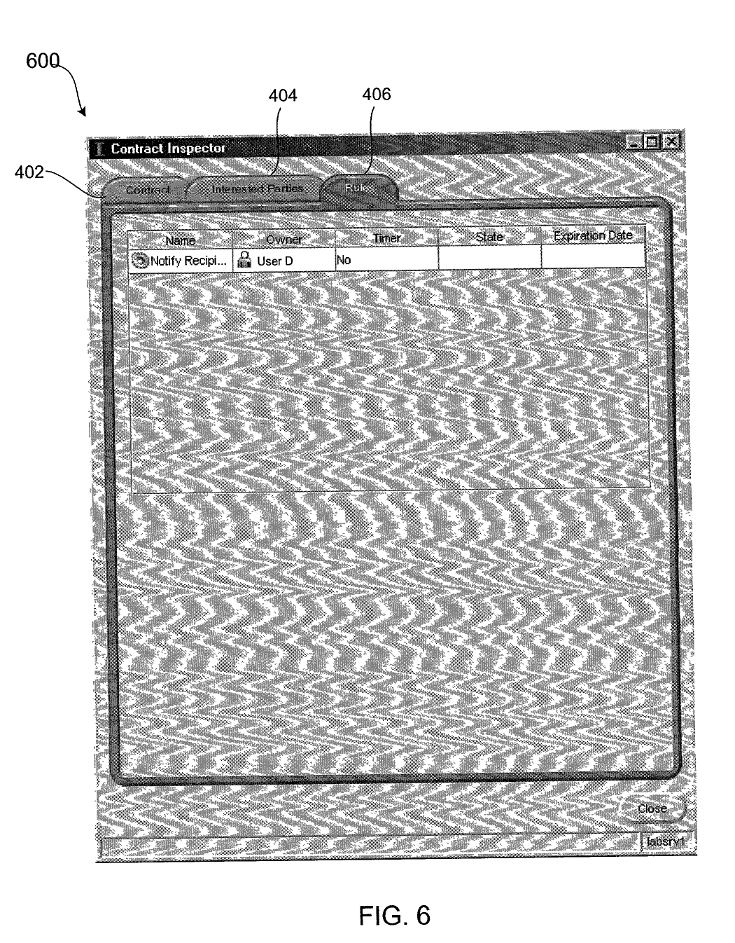

As noted, contracts can also have rules associated with them. These rules enable various automated functions (e.g., notification) to be activated upon a change in an aspect of the contract. The selection of Rules tab 406 enables rule information to be obtained through user interface screen 600 of FIG. 6, which illustrates the rules that are associated with contract B. In the illustrated example, a notification rule has been defined for contract C.

As thus described, contracts provide an efficient mechanism for incorporating informal deliverable information into an automated enterprise management system. This deliverable information can be built up incrementally over time as the deliverable is further defined. What results is a new form of peer-to-peer communication that enables the methodical capture and communication of project planning information.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for enabling management in a work environment, comprising:
storing contract information that describes an agreement for a contract provider to provide a deliverable to a contract customer without providing details of how said deliverable is to be produced by said contract provider; and
displaying, in a graphical display, a contract icon associated with said contract information at an intersection point between a provider icon associated with said contract provider and a customer icon associated with said contract customer.

2. The method of claim 1, wherein said contract information is implemented as a software object.

3. The method of claim 2, wherein said contract object includes a contract description attribute that describes said deliverable, and a contract state attribute that identifies a current state of said contract object.

4. The method of claim 3, wherein said contract state attribute includes a value taken from a set of proposed, agreed, delivered, and completed values.

5. The method of claim 1, wherein one of said provider icon and said customer icon is associated with an activity.

6. The method of claim 5, wherein one of said provider icon and said customer icon is associated with a project.

7. The method of claim 5, wherein one of said provider icon and said customer icon is associated with a summary task.

8. The method of claim 5, wherein one of said provider icon and said customer icon is associated with a task.

9. The method of claim 5, wherein one of said provider icon and said customer icon is associated with a workflow activity.

10. The method of claim 1, wherein one of said provider icon and said customer icon is associated with a resource.

11. The method of claim 10, wherein one of said provider icon and said customer icon is associated with a user.

12. The method of claim 10, wherein one of said provider icon and said customer icon is associated with a role.

13. The method of claim 10, wherein one of said provider icon and said customer icon is associated with a team.

14. The method of claim 1, wherein said displaying comprises displaying said contract icon at an intersection point between said provider icon and a plurality of customer icons associated with a plurality of contract customers.

15. The method of claim 1, wherein said displaying comprises displaying said contract icon at an intersection point between said customer icon and a plurality of provider icons associated with a plurality of contract providers.

16. The method of claim 1, wherein said displaying comprises displaying said contract icon at an intersection point between a plurality of provider icons associated with a plurality of contract providers and a plurality of customer icons associated with a plurality of contract customers.

17. A method for enabling management in a work environment, comprising:
storing contract information that describes a peer-to-peer agreement for a contract provider to provide a deliverable to a contract customer; and
displaying, in a graphical display, a contract icon associated with said contract information at an intersection point between a provider icon associated with a first activity and a customer icon associated with a second activity, wherein said first activity and said second activity represent work performed within an organization.

18. The method of claim 17, wherein one of said provider icon and said customer icon is associated with a project.

19. The method of claim 17, wherein one of said provider icon and said customer icon is associated with a summary task.

20. The method of claim 17, wherein one of said provider icon and said customer icon is associated with a task.

21. The method of claim 17, wherein one of said provider icon and said customer icon is associated with a workflow activity.

22. A graphical user interface that enables management in a work environment, comprising:
a contract provider icon, said contract provider icon enabling a user to retrieve information regarding a first resource or activity;
a contract customer icon, said contract customer icon enabling a user to retrieve information regarding a second resource or activity; and
a contract icon displayed at an intersection of said contract provider icon and said contract customer icon, said contract icon enabling a user to retrieve information regarding an agreement for said contract provider to provide a deliverable to said contract customer.

23. The graphical user interface of claim 22, wherein one of said contract provider icon and said contract customer icon enables a user to retrieve information regarding a project.

24. The graphical user interface of claim 22, wherein one of said contract provider icon and said contract customer icon enables a user to retrieve information regarding a summary task.

25. The graphical user interface of claim 22, wherein one of said contract provider icon and said contract customer icon enables a user to retrieve information regarding a task.

26. The graphical user interface of claim 22, wherein one of said contract provider icon and said contract customer icon enables a user to retrieve information regarding a workflow activity.

27. The graphical user interface of claim 22, wherein one of said contract provider icon and said contract customer icon enables a user to retrieve information regarding a user.

28. The graphical user interface of claim 22, wherein one of said contract provider icon and said contract customer icon enables a user to retrieve information regarding a role.

29. The graphical user interface of claim 22, wherein one of said contract provider icon and said contract customer icon enables a user to retrieve information regarding a team.

30. A computer program product, comprising:
computer-readable program code for causing a computer to store contract information that describes an agreement for a contract provider to provide a deliverable to a contract customer without providing details of how said deliverable is to be produced by said contract provider;
computer-readable program code for causing a computer to display, in a graphical display, a contract icon associated with said contract information at an intersection point between a provider icon associated with said contract provider and a customer icon associated with said contract customer; and
a computer-usable medium configured to store the computer-readable program codes.

31. A computer program product, comprising:
computer-readable program code for causing a computer to store contract information that describes a peer-to-peer agreement for a contract provider to provide a deliverable to a contract customer;
computer-readable program code for causing a computer to display, in a graphical display, a contract icon associated with said contract information at an intersection point between a provider icon associated with a first activity and a customer icon associated with a second activity, wherein said first activity and said second activity represent work performed within an organization; and
a computer-usable medium configured to store the computer-readable program codes.
